(19) United States
(12) Patent Application Publication
(10) Pub. No.: US 2025/0382939 A1
(43) Pub. Date: Dec. 18, 2025

(54) HYDRAULIC MACHINE COMPRISING A DOG BRAKE

(71) Applicant: POCLAIN HYDRAULICS INDUSTRIE, VERBERIE (FR)

(72) Inventor: Maxime THIBAULT, VERBERIE (FR)

(21) Appl. No.: 18/878,258

(22) PCT Filed: Jul. 4, 2023
(86) PCT No.: PCT/FR2023/051024

§ 371 Date: Dec. 23, 2024

(30) Foreign Application Priority Data
Jul. 8, 2022 (FR) FR2207057

(51) Int. Cl. F03C 1/32; F04C 29/00

(52) U.S. Cl. CPC F03C 1/0415; F04C 29/00; F04C 2230/60

(57) ABSTRACT

Disclosed is a hydraulic machine (2) comprising:—a bearing support member (8),—a cylinder block (16),—a brake piston (20) that is movably mounted with respect to the bearing support member between a braking position in which the piston is shape-matchingly engaged with the cylinder block in such a way as to prevent the cylinder block from rotating with respect to the piston and a brake-release position in which the piston lets the cylinder block rotate freely with respect to the piston, and—at least one bearing (14) supported by the bearing support member (8), the piston and the bearing being on the same side of the cylinder block with reference to the direction of a main axis (X-X) of the machine, a perimeter (59) of the piston (20), oriented in the opposite direction to the axis, being configured so as to prevent the piston from rotating with respect to the bearing support member.

### FIELD OF THE INVENTION

The invention concerns hydraulic machines.

### STATE OF THE ART

From document FR-2 765 637 a rotary hydraulic machine is known comprising a shaft, a cam and a cylinder block secured to the rotating shaft and carrying pistons able to follow the cam. The shaft is carried by bearings supported by a bearing support. The machine comprises a brake of dog brake type which comprises a piston mounted mobile with the bearing support between a braking position in which the piston blocks rotation of the cylinder block, and a brake release position in which the piston leaves the cylinder block free to rotate. The bearings and the brake pistons lie on different sides of the cylinder block with reference to the direction of a rotation axis of the machine.

Yet, it is desired—in particular for reasons of compactness—to provide a machine in which, on the contrary, the brake piston and bearings lie on one same side of the cylinder block. However, this configuration raises problems of bulk for housing of the brake piston.

It is one objective of the invention to obtain a hydraulic machine meeting this desire.

### SUMMARY OF THE INVENTION

For this purpose, provision is made in the invention for a hydraulic machine comprising:
a bearing support member,
a cylinder block,
a brake piston movably mounted with respect to the bearing support member between a braking position in which the piston is shape-match engaged with the cylinder block so as to block rotation of the cylinder block with the piston, and a brake release position in which the piston leaves the cylinder block free to rotate in relation to the piston, and
at least one bearing supported by the bearing support member, the piston and the bearing lying on one same side of the cylinder block with reference to the direction of a main axis of the machine,
a perimeter of the piston oriented radially in the opposite direction to the axis being conformed to block rotation of the piston in relation to the bearing support member.

In the present application, the expression « in the opposite direction to the axis » means radially outer, and « in the direction of the axis » means radially inner.

Therefore, this architecture allows suitable housing of the brake piston without loss of volume even though the piston and bearing lie on one same side of the cylinder block.

Provision can be made for the bearing support member to comprise a first part and a second part assembled onto the first part, the first and second parts together forming a housing to receive the piston.

This is a solution of interest to obtain the arrangement of the invention. In particular, by means of this arrangement in two parts, the bearing support member is easy to manufacture despite the fact that the shape thereof can be complicated since it must cooperate with the piston.

Provision can be made so that the second part forms an abutment to prevent the piston from moving outside the housing.

Provision can be made for the bearing support member to form a groove opening in the direction of the cylinder block; the groove receiving the piston.

The machine having symmetry of revolution, this groove is annular. Provision can be made for example that it continues around the bearing.

Provision can be made for the machine to comprise a cam and securing members passing through the cam, the perimeter of the piston comprising extensions extending, in a direction radial to the axis, so that they coincide with zones lying between the securing members or in the continuation of these zones in a direction parallel to the axis.

Therefore, the extensions preventing rotation of the piston are housed without taking up much volume, namely in the spaces left free by the securing members or in the continuation of these spaces in the axial direction.

Provision can be made for the piston to have cavities opening in the direction of the axis and extending perpendicular to the extensions in a direction radial to the axis.

The mass of the piston is thereby reduced. In addition, while the extensions on the bearing ensure the reinforcing thereof, the extensions on the piston take part in reinforcing the piston, in particular if they form ribs.

Provision can be made for the bearing support member to have extensions extending into the cavities of the piston.

Therefore, these extensions ensure reinforcing of the bearing support member to better take up the forces transmitted by the shaft bearing or bearings.

Provision can be made for the perimeter of the piston and/or the bearing support member to have surfaces conformed to block rotation of the piston relative to the bearing support member, and obtained by forming operations without machining.

Therefore if these surfaces are left untreated, the manufacture of the machine is simplified.

Provision can be made for the machine to comprise a shaft carrying an abutment to form an obstacle against sliding of the cylinder block in the direction of the axis.

If there is no such obstacle, demand on the brake piston against the cylinder block could generate axial displacement of the latter relative to the shaft. This abutment allows this risk to be avoided by means of a reduced number of parts since it is the shaft which carries the abutment. This avoids using a large number of parts which would generate an accumulation of tolerances resulting from the chain of dimensions involved.

The invention also provides a method for manufacturing a machine of the invention, wherein
the piston is formed other than by machining, with some faces of the perimeter conformed to prevent rotation of the piston relative to the bearing support member, the faces being in the as-formed state, and
the piston is assembled onto the bearing support member with the faces in the as-formed state.

Therefore, the need for one or more machining operations is avoided, in particular cutting operations (e.g. milling) on the faces of the perimeter conformed to prevent rotation of the piston relative to the bearing support member. Manufacturing of the machine is therefore simplified. However, it remains possible to obtain some parts of the piston by machining. Therefore. a piston deburring step and piston lathe machining step can be carried out. The forming step can be performed by forging or moulding of the piston.

The invention also provides a method for manufacturing a machine of the invention wherein:
the bearing support member is formed other than by machining, with some faces of the bearing support member being conformed to prevent rotation of the piston relative to the bearing support member; the faces of the bearing support member conformed to prevent rotation being in the as-formed state, and
the piston is assembled onto the bearing support member with the faces of the bearing support member conformed to prevent rotation being in the as-formed state.

In the invention a manufacturing method is also provided wherein
the bearing support member is formed other than by machining, with extensions in an as-formed state; and
the piston is assembled onto the bearing support member with the extensions in the as-formed state.

Provision can be made for machining the piston and/or bearing support member.

Provision can be made so that the method entails:
assembling of the brake piston with the bearing support member, and
mounting of the assembly on a casing or rotating part of the machine.

It can be provided that the method comprises at least one of the following characteristics:
the first part is assembled onto the second part by placing the piston between the first and second parts;
at least one spring is arranged in the first part and the brake piston is assembled onto the second part inserting seals between the brake piston and the second part; and
a sealing element is inserted between opposite-facing surfaces of the first and second parts.

This sealing can be obtained using seals, a sealing compound, or any other sealing means at the interface between the parts.

### DESCRIPTION OF THE FIGURES

A description of one embodiment of the invention is given below as a nonlimiting example supported by the drawings in which:

FIG. 1 is a semi-view in a representative axial cross-section of a machine according to one embodiment of the invention;

FIGS. 2 and 3 are axial cross-sectional views of the machine in this embodiment;

FIGS. 4 to 7 are perspective axial cross-sectional views of some parties of the machine in FIG. 2;

FIGS. 8 to 11 are perspective views of the first part of the bearing support member, brake piston and second part of the bearing support member respectively of the machine in FIG. 2; and

FIG. 12 is a cross-sectional view of the machine in FIG. 2 showing some of the parts thereof.

### THE MACHINE

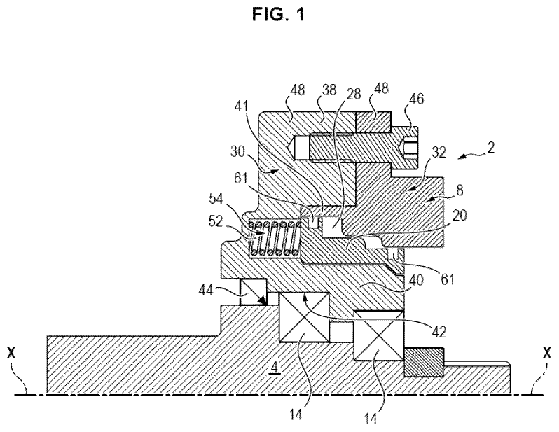

In connection with FIGS. 1 to 12, a description is now given of a rotary hydraulic machine 2 according to one embodiment of the invention.

With reference in particular to FIGS. 1 to 3, the machine comprises a shaft 4 having a longitudinal axis X-X forming an axis of rotation of the machine. It comprises a casing 6 comprising a bearing support member 8 and a distribution cover 10 arranged either side of a multilobed cam 12 to which they are rigidly secured. It comprises two rolling bearings 14. The bearings carry the shaft 4 and, in radial direction to axis X-X, they bear against the bearing support member 8 in shoulders formed in the latter. The shaft forms an output shaft and comprises a driving element at its outer end, namely a flange for a wheel, or pinion for a chain or caterpillar track for example.

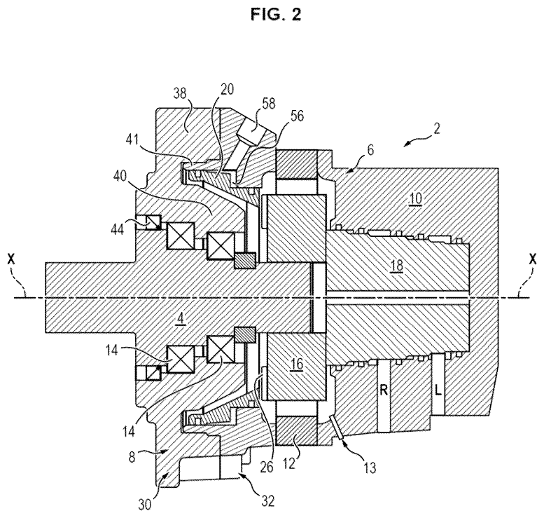

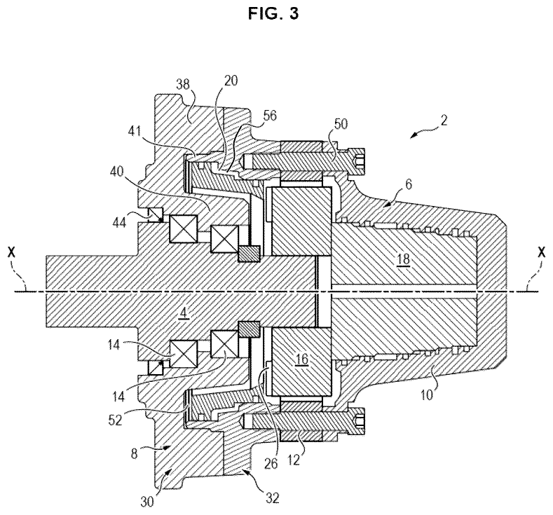

The machine comprises a cylinder block 16 particularly illustrated in FIGS. 2 and 3 rotatably connected to the shaft 4 and having a structure that is known per se and will not be detailed. It has cylindrical housings radial to the axis in which cam pistons are housed mounted slidingly in radial direction and bearing upon the cam 12 by means of a bearing roller.

The chamber delimited by the casing comprises a liquid at a casing pressure. A drain 13 which can be seen in FIG. 2 allows draining thereof whenever necessary.

The machine comprises a distributor 18 extending in the axial continuation of the shaft 4 and in the distribution cover 10. In manner known per se, the distributor 18 ensures the connecting of the piston housings with high pressure and low pressure fluid circuits. The machine can operate as a motor or as a pump. When operating in motor mode, the high pressure of fluid in the high pressure circuit causes movement of the pistons, rolling of the rollers on the multilobed cam 12 and in fine rotation of the shaft 4 relative to the casing 6, resulting in the driving in rotation of a load secured to the shaft or casing. In pump mode, on the contrary, this input rotation causes movement of the piston in their housings and the placing under pressure and movement of the fluid in the high pressure circuit. For more details on the general structure of the machine and how it operates, reference can be made for example to aforementioned document FR-2 765 637.

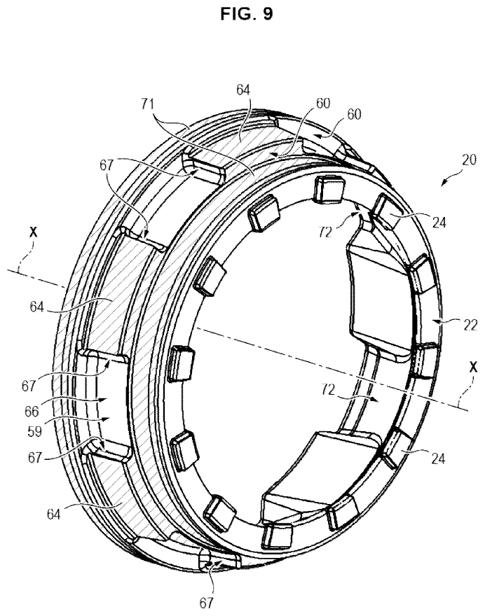

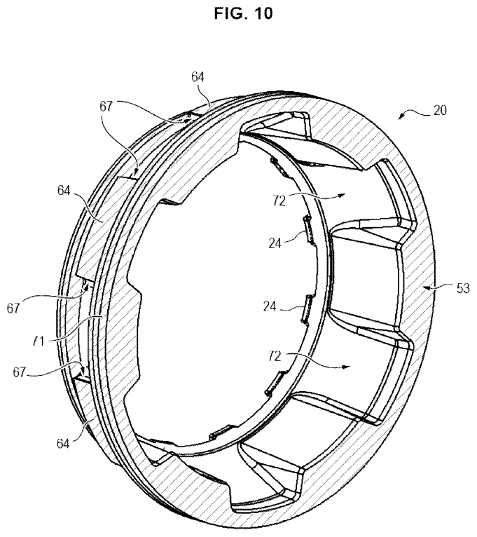

The machine comprises a brake piston 20 particullarly illustrated in FIGS. 9 and 10. Like most parts of the machine, it has a shape globally having symmetry of revolution about the axis X-X. The brake piston 20 and bearings 14 lie on the same side of the cylinder block 166 with reference to a direction of the main axis X-X, as can be particularly seen in FIGS. 1 to 3.

The brake piston 20 is of general annular shape. On one axial end face 22 directed towards the cylinder block 16, it has gearing comprising teeth 24 projecting outwardly from the face in the direction of the axis. The cylinder block 16, on an axial end face directed towards the piston, has matching gearing comprising teeth 26.

The brake piston is received in a housing 28 of the bearing support member 8. It is mounted slidingly mobile in relation to the bearing support member 8 in the axial direction between:
a braking position in which the piston 20 is shape-match engaged with the cylinder block 16 so as to block rotation of the cylinder block in relation to the piston, and
a brake release position in which the piston 20 leaves the cylinder block free to rotate in relation to the piston.

In the braking position, the closest to the cylinder block, the teeth 24 of the piston are engaged with those of the cylinder block 16, and the shaft 4 is unable to rotate relative to the casing. In the brake release position, the furthest away from the cylinder block, the teeth of the piston are disengaged from those of the cylinder block and the shaft is able to rotate relative to the casing. It is therefore a dog brake.

The bearing support member 8 here comprises a first part 30 and a second part 32 assembled onto the first part, the first and second parts together forming the housing 28. The two parts are of general annular shape with symmetry of revolution about the axis.

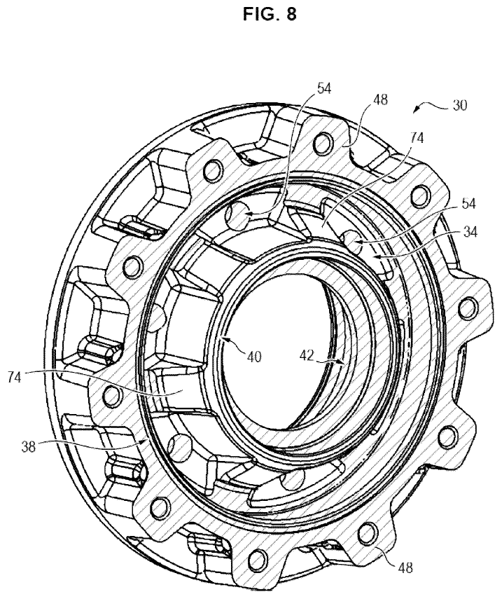

The first part 30 is particularly illustrated in FIG. 8. It has a general U-shaped profile on one side of the axis, as seen in cross-section in the radial plane in FIG. 2. It therefore has a groove 34 opening in direction of the cylinder block 16, the groove receiving the brake piston 20. This groove, in the first part, therefore separates a peripheral portion 38, the furthest distant from the axis, from a central portion 40 the closest to the axis. The peripheral portion 38 bears against the cam 12 in the axial direction, unlike the central portion 40 which does not bear upon the cam.

The central portion 40 is in contact with the bearings 14 which bear upon the inner surface thereof 42 oriented towards the axis, against two shoulders of this central portion. A seal 44 bears upon the shaft and upon the inner surface 42.

A skirt 41 of the second part 32 extends into the first part 30 in the axial direction and bears radially upon the peripheral portion 38. It ensures mutual centring of the two parts 30 and 32 of the bearing support member.

As particularly illustrated in FIGS. 1, 6 and 7, the first and second parts 30, 32 are rigidly and directly secured to each other via securing members 46 extending in directions parallel to the axis and away therefrom. Here each of the two parts, on the perimeter thereof, comprises raised parts or extensions 48. Each securing member 46 passes through an extension 48 of the first part 30 and an extension 48 of the second part 32. These members 46 are formed here by screws of which a head bears against the second portion 32.

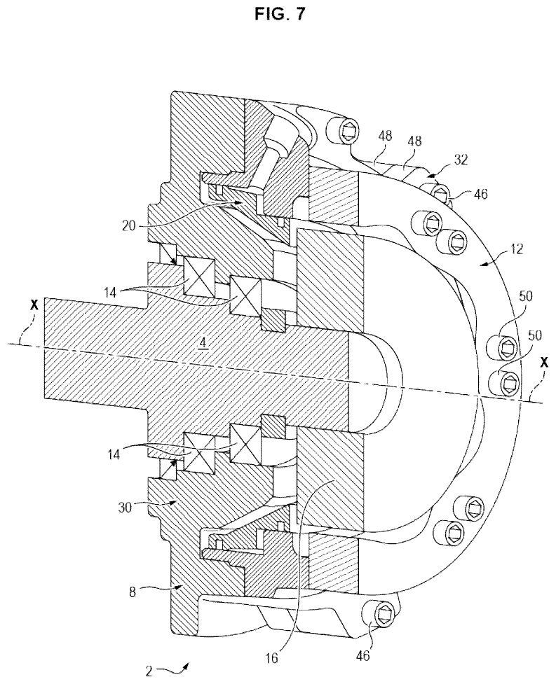

As particularly illustrated in FIGS. 3 and 7, the distribution cover 10, cam 12 and second part 32 are rigidly secured to each other via securing members 50 extending in directions parallel to the axis, and away therefrom. Each securing member 50 passes through the distribution cover 10, cam 12 and second part 32. These members 50 here are formed of screws of which a head bearing against the distributor.

The machine 2 comprises return springs 52 tending to place demand on the brake piston 20 in the direction of the cylinder block 16, and hence in braking position. Here, as illustrated in FIGS. 1 and 8, the first part 30 has cavities 54 arranged in the bottom of the groove 34. Each spring 52 bears against the bottom of the associated cavity 54 and also against a planar surface 53 of an axial end of the brake piston 20 perpendicular to the axis and oriented towards the groove.

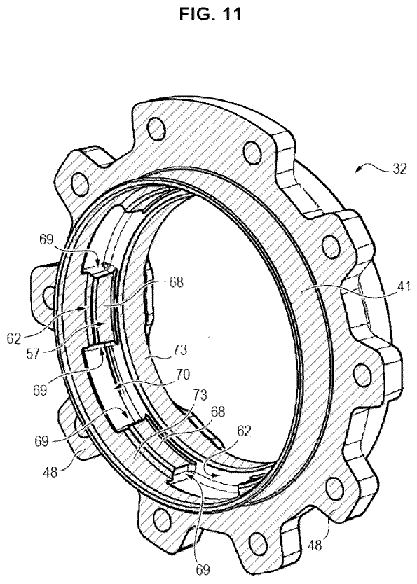

The machine comprises a hydraulic control chamber of the brake. It is a brake release chamber 56 positioned in the housing 28 of the bearing support member 8. It is delimited by an inner perimeter 57 of the second part 32 oriented in the direction of the axis and, opposite the latter, by an outer perimeter 59 of the piston 20 oriented in opposite direction to the axis. Two seals 61 in contact with these perimeters delimit the chamber 56. A control line 58 passes through the second part 32 in the direction of the axis to feed the chamber 56 with control fluid. Since the chamber is delimited by planar faces 60 of the piston, which can particularly be seen in FIG. 9, and by planar faces 62 of the second part (particularly shown in FIG. 11), all perpendicular to the axis, adapted pressure of the fluid in the brake release chamber 56 causes recoiling of the piston against the springs 52 so that it moves into brake release position. Here, by means of these opposite-facing surfaces 60, 62, the second part 32 forms an abutment preventing the piston from moving outside the housing 28. The bearing support member alone is therefore configured to block any egress of the piston from the housing 28.

The piston 20 changes from a brake release position to a braking position via a sliding movement in the second part 32.

Guiding of the axial sliding of the piston can be obtained by sliding of the seals 61 over a machined surface. In the illustrated embodiment, the seals are carried by the brake piston (in grooves made on the outer radial portion of the piston 20), but it could be envisaged that the seals 61 lie in grooves made in the inner perimeter 58 oriented in direction of the axis of the second part 32 (it could also be envisaged that one of the seals 61 is on the piston 20 and the other seal 61 is on the second part 32). In general, the surfaces on which a seal-carrying groove is formed may or may not be machined; on the other hand, the surfaces on which the seals slide (antagonist surfaces) must necessarily be machined. In the described embodiment, the surfaces 71 of the piston in which the grooves are formed are machined, and the surfaces 73 of the second part on which the seals 61 slide are also machined.

Anti-rotation for the sliding movement is obtained by the as-forged or as-demoulded surfaces of the extensions 64 of the brake piston 20 cooperating with the as-forged or as-demoulded surfaces of the extensions 68 of the second part 32, as will be seen below.

Guiding of the brake piston 20 sliding in relation to the bearing support member 8 is accompanied by an anti-rotation function whereby the relative rotation thereof is prevented. This function is ensured by shapes of the piston 20 and of the second part 32. More specifically, the outer perimeter 59 of the piston oriented in an opposite direction to the axis and the inner perimeter 57 of the second part 32 oriented towards the axis are conformed to prevent rotation of the piston relative to the bearing support member, in addition to also delimiting the brake release chamber 56 as explained above.

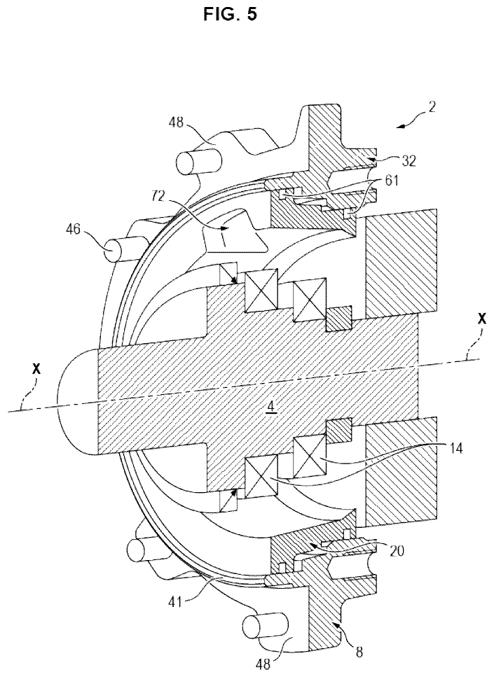

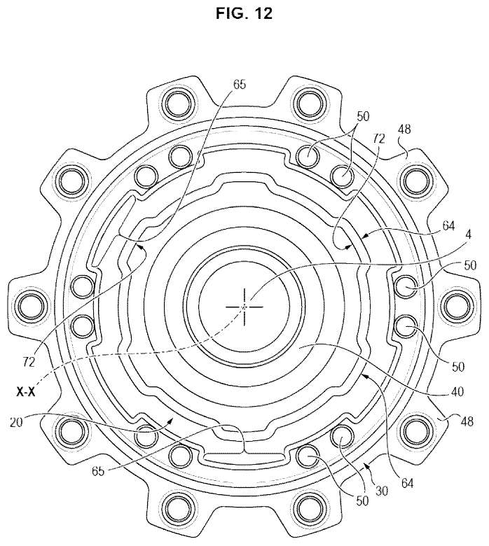

As illustrated in particular in FIG. 9, for this purpose the outer perimeter 59 of the piston here comprises extensions 64 forming spaced-apart crenellations projecting from a cylindrical surface 66 of this periphery in a direction radial to the axis. Similarly, and matching therewith, as particularly illustrated in FIG. 11, the inner perimeter 57 of the second part 32 for this purpose comprises extensions forming spaced-apart crenellations projecting from a cylindrical surface 70 of this perimeter in the direction radial to the axis. The extensions 64 of the piston are arranged between those 68 of the second part. The extensions 64, 68, via their respective side facets 67, 69 lying in planes radial to the axis, therefore block rotation of the piston. As will be seen below, these facets 67, 69 are in the as-forged state and do not result from a machining operation. As illustrated in FIGS. 5 and 12, the extensions 64 of the piston in this example extend in a continuation following the axis of zones 65 forming arches and positioned between the securing members 50 securing the distributor and cam to the bearing support member 8.

Each extension 64 of the piston 20 is inserted between two extensions 68 of the second part, which means that one of the extensions 68 comes into contact with an extension 64 of the piston at the time of braking in rotational direction, and respectively the other extension 68 comes into contact with extension 64 at the time of braking in the other rotational direction. This corresponds to a machine able to drive and brake in both rotational directions, for forward and back travel. The extension 64 of the piston is in contact with an extension 68 of the second part via one of the facets 67 thereof in one braking direction, and by the other facet 67 in the other braking direction. The extensions 64 and 68 take part in a sliding connection of the piston in the bearing support member. In particular, the non-machined side facets 67, 69 of the extensions 64 and 68 slide opposite each other at the time of a braking or brake release operation. On movement of the piston 20, the machined surfaces 64 and 70, and 71, 73 extending in the circumferential direction slide upon each other.

Also, as illustrated in FIG. 10, the piston 20 has cavities 72 opening in the direction of the axis and extending perpendicular to the extensions 64 in a direction radial to the axis. As illustrated in FIG. 8, the bearing support member has extensions 74 extending into the cavities 72 of the piston. These extensions here lie on the outer perimeter of the central portion 40 of the first part 30 of the bearing support member. These extensions form reinforcements to take up the forces transmitted by the bearings 14.

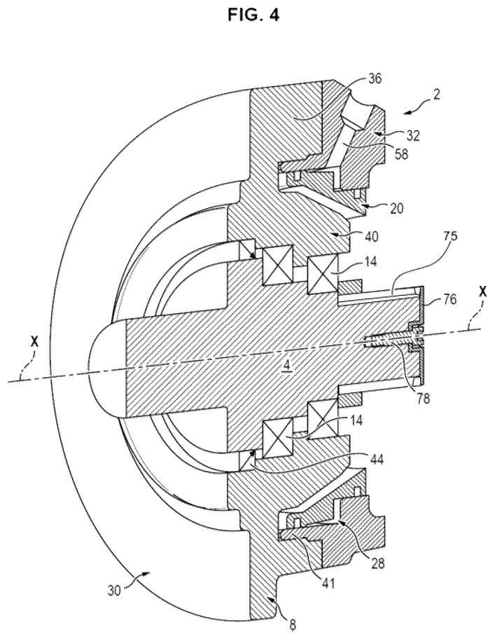

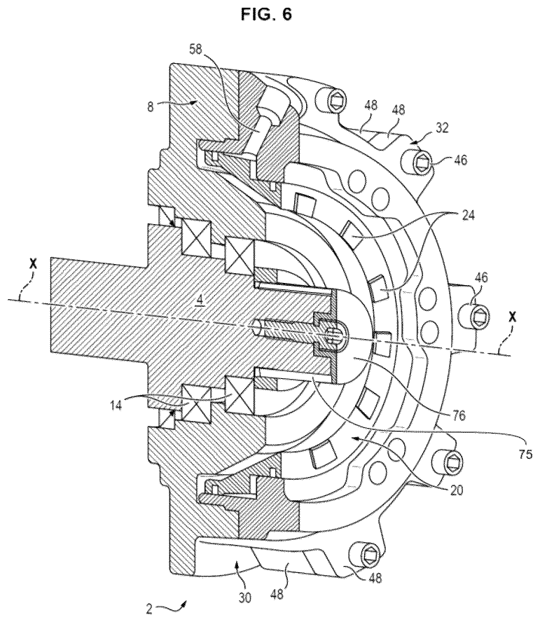

As illustrated in FIG. 6, the shaft 4 comprises splines 75 (only illustrated in some Figures—in particular FIGS. 4 and 6) to drive the block in rotation, and this shaft 4 also carries an abutment 76 forming an obstacle against sliding of the cylinder block 16 in the direction of the axis relative to the shaft. The abutment in this example is formed by a disc or washer 78 rigidly secured to the end of the shaft and coaxially with the shaft, by means of a screw 78 for example. The washer extends via its outer edge projecting from the cylindrical surface of the shaft and opposite, in the axial direction, the face of the cylinder block 16 oriented in opposite direction to the brake piston, to that it blocks sliding of the cylinder block when stressed by the piston. The blocked sliding of the cylinder block in relation to the shaft can also be obtained by means of a stop part force-mounted at the axial end of the shaft (e.g. by shrink-fitting) or by a stop ring (of circlip type) received in a groove of the shaft. The advantage of all the solutions put forward herein is that they allow controlled axial clearance of the cylinder block in relation to the shaft. Without these stop solutions, axial blocking of the cylinder block could be obtained against the casing 6 or distributor 18, but this would entail much less flexibility in the chain of dimensions for the axial clearances of the different parts of the motor in relation to each other and, at worst, would risk deteriorating the distributor or casing or even the cylinder block. Alternatively, this solution would require inserting a rotating sliding member between the casing and the cylinder block, such as a sliding washer or a ball or roller thrust bearing.

### Manufacturing Method

The machine 2 can be manufactured following one embodiment of the method of the invention which comprises the following steps.

In the preferred embodiment, the brake piston 20 illustrated in FIGS. 9 and 10 is obtained with a die forging step. A forged part is more suitable for obtaining the brake piston 20 in particular on account of the mechanical strength it is desired to obtained at the dog teeth.

At this step, the piston is forged conforming the cylindrical face 66 and facets 67 of the extensions 64 on the outer perimeter 59 to prevent rotation of the piston in relation to the bearing support member 8. The piston is then removed from the die so that the facets thereof are in the as-forged state. Alternatively, the piston forged in the preferred embodiment and the other components presented as moulded in the preferred embodiment can be obtained by other uniaxial conforming means such as injection-moulding or sintering along axis XX, or in equivalent manner via other means such additive manufacturing or 3D printing. The term « forming » is used to designate all such obtaining means other than machining in the remainder of the description.

The next step is a reworking step (in particular by lathe machining) of some faces of the piston. Here, this concerns the axial end face 53 oriented towards the bottom of the groove 34 and the cylindrical faces 71 oriented in opposite direction to the axis, with the exception of face 66 carrying the extensions 64. These are the hatched faces in FIGS. 9 and 10. All the non-machined faces of the piston and in particular the facets 67 are therefore left in the as-formed state (thereby avoiding more costly milling operations to obtain the crenellations).

Similarly, with reference to FIG. 8, the first part 30 of the bearing support member is obtained by injection-moulding. At this step, this part is moulded with the reinforcing extensions 74 on the perimeter. This part is then released from the mould so that these extensions are in the as-demoulded state.

A reworking step is then performed (by lathe machining in particular) on some faces of this part 30. Here, it is on the peripheral portion of the axial end face coming into contact with the second part 32 and opposite-facing surface. On the central portion, it also concerns the planar and cylindrical surfaces forming the shoulders to receive the bearings 14. The machined faces are hatched in FIG. 8. All the other faces are left in the as-demoulded state (thereby avoiding more costly milling operations to form the crenellations).

Similarly, the second part 32 of the bearing support member is formed by injection moulding as shown in FIG. 11. At this step, this part is moulded by conforming the cylindrical face 70 and faces 69 of the extensions 68 on the inner perimeter to prevent rotation of the piston in relation to the bearing support member. This part is then released from the mould so that these faces 69 are in the as-demoulded state.

A reworking step is then performed (in particular by lathe machining) on some faces of this part 32. Here, it is the faces of the skirt 41, the face perpendicular to the axis which comes to bear against the first part 30, and the cylindrical faces 73 upon which the piston comes to bear when sliding. The machined faces are hatched in FIG. 11. However, all the other faces are left in the as-demoulded state, in particular the facts 69 (thereby avoiding milling operations to form the crenellations).

For the piston 20, as for the first part 30 or second part 32 of the bearing support member, the faces of the extensions have a draft angle in the axial direction i.e. they are slightly inclined to allow ejection from the mould (or from the forging die) along axis X-X. For example, these non-reworked faces are not cylindrical along the axis X-X and are in fact slightly conical. All the as-demoulded (or as-forged) faces have this characteristic of draft angle in this embodiment. The as-demoulded (or as-forged) faces also have greater roughness than the re-machined surfaces.

The draft angle is typically 4° on the non-reworked faces of the piston 20 as on the faces of the second part 32. Such a draft angle allows limiting of the force needed to move the piston in relation to the bearing support member in the brake release direction. The smaller the draft angle, the greater the friction to be overcome to disengage the brake piston from the second part 32 of the bearing support member.

Thereafter, the piston 20, the first and second parts 30, 32, and the other components of the machine are assembled, with the faces indicated above that were left in the as-demoulded (or as-forged) state remaining in this state at the time of assembly. When mounting, the first part 30 is assembled onto the second part 32 inserting the piston 20 therebetween so that it is trapped in the housing.

The assembling of the first part 30 onto the second part 32 is obtained with the following steps:
inserting the springs 52 in the cavities 54 of the groove 34 of the first part 30;
inserting the brake piston 20 equipped with its two seals 61 in the second part 32, the part 32 forming an abutment to retain the brake piston 20 in a direction of movement, then
assembling the first part 30 equipped with its springs with the second part 32 comprising the brake piston 20 equipped with its seals 61, via screws 46. Preferably, this assembling is sealed assembling (using a seal, seal compound or any other sealing means at the interface between the parts 30 and 32).

Once assembled, the parts 30 and 32 form a sub-assembly of the motor that can be mounted independently (the parts thereof being as one). This sub-assembly is then assembled as such onto the other components of the machine.

Therefore, the anti-rotation function of the piston is obtained on non-reworked bearing surfaces. The moulded (or forged) components do not require a complicated machining step. It is sufficient to use lathe machining steps. This allows a reduction in manufacturing cost.

The invention therefore provides a negative parking brake of dog type positioned on the same side of the cylinder block as the bearings. The sliding connection and blocked rotation of the brake piston are obtained here between the two seals 61 within the control chamber 28.

As has been seen, the brake piston has specific shapes on the inner and outer diameters thereof. The inner shapes formed by the cavities 72 are not used to block rotation thereof, but are used to prevent any interference with the extensions 74 rigidifying the first part 30 of the bearing support member. Since the anti-rotation function of the brake piston 20 is obtained on the outer perimeter thereof, there remains an available volume in the bearing support member to position these reinforcing extensions 74 therein, adding thickness to solidify this component.

Since anti-rotation is obtained on an outer diameter of the brake piston 20, compared with a device having anti-rotation of the brake piston on an inner diameter of the latter, application of an equivalent brake torque transmitted to the cylinder block entails less force on the side facets of the extensions 64, 68 (since the leverage is greater).

Numerous modifications can be made to the invention without departing from the scope thereof.

The shape of the housing 28 receiving the piston can be modified. The bearing support member can be manufactured in a single part or in more than two parts.

1. A hydraulic machine,
the hydraulic machine comprising:
a bearing support member,
a cylinder block,
a brake piston movably mounted with respect to the bearing support member between a braking position in which the brake piston is shape-matchingly engaged with the cylinder block in such a way as to prevent the cylinder block from rotating with respect to the brake piston, and a brake-release position in which the brake piston allows the cylinder block to rotate freely with respect to the brake piston, and
at least one bearing supported by the bearing support member, the brake piston and the bearing being on the same side of the cylinder block with reference to a direction of a main axis of the machine,
a perimeter of the brake piston oriented radially in an opposite direction to the main axis being configured to prevent the brake piston from rotating with respect to the bearing support member.

2. The machine according to claim 1, wherein the bearing support member comprises a first part and a second part assembled onto the first part, the first part and the second part together forming a housing receiving the brake piston.

3. The machine according to claim 2, wherein the second part forms an abutment against egress of the brake piston outside the housing.

4. The machine according to claim 1, wherein the bearing support member forms a groove opening in direction of the cylinder block, the groove receiving the brake piston.

5. The machine according to claim 1, the machine comprising a cam and securing members passing through the cam,
the perimeter of the brake piston comprising extensions extending in a direction radial to the main axis to coincide with zones lying between the securing members or in a continuation of these zones in a direction parallel to the main axis.

6. The machine according to claim 5, wherein the brake piston has cavities opening in direction of the main axis and extending perpendicular to the extensions in a direction radial to the main axis.

7. The machine according to claim 1, wherein the bearing support member has extensions extending into cavities of the brake piston.

8. The machine according to claim 1, wherein a perimeter of the brake piston member has faces conformed to block rotation of the brake piston in relation to the bearing support member, and resulting from forming operations without machining.

9. The machine according to claim 1, which comprises a shaft carrying an abutment forming an obstacle against sliding of the cylinder block in the direction of the main axis.

10. A method for manufacturing a machine according to claim 1, comprising:
forming the brake piston other than by machining, a perimeter of the brake piston having faces conformed to prevent rotation of the brake piston in relation to the bearing support member, the faces being in the as-formed state, and
assembling the brake piston onto the bearing support member with the faces in the as-formed state.

11. A method for manufacturing a machine according to claim 1, comprising:
forming the bearing support member other than by machining, with faces of the bearing support member conformed to prevent rotation of the brake piston in relation to the bearing support member, the faces of the bearing support member conformed to prevent rotation being in the as-formed state, and
assembling the brake piston onto the bearing support member with the faces of the bearing support member conformed to prevent rotation being in the as-formed state.

12. A method for manufacturing a machine according to claim 7, comprising:
forming the bearing support member other than by machining, with the extensions in the as-formed state, and
assembling the brake piston onto the bearing support member with the extensions in the as-formed state.

13. The method according to claim 10, comprising machining the brake piston .

14. The method according to claim 10, comprising:
preparing an assembly is prepared comprising the brake piston connected to the bearing support member, and
mounting the assembly on a casing of the machine.

15. The method according to claim 10, comprising:
assembling a first part of the bearing support member onto a second part of the bearing support member, and,
inserting the brake piston between the first and second parts of the bearing support member,
the first part and the second part of the bearing support member together forming a housing receiving the brake piston.

16. The method according to claim 15, comprising:
arranging at least one spring in the first part of the bearing support member, and,
assembling the brake piston onto the second part of the bearing support member with interposing of seals between the brake piston and the second part of the bearing support member.

17. The method according to claim 15, comprising interposing a sealing element between opposite-facing surfaces of the first and second parts of the bearing support member.

18. The machine according to claim 1, wherein a perimeter of the bearing support member has faces conformed to block rotation of the brake piston in relation to the bearing support member, and resulting from forming operations without machining.

19. The method according to claim 10, comprising machining the bearing support member.

20. The method according to claim 10, comprising:
preparing an assembly comprising the brake piston connected to the bearing support member, and
mounting the assembly on a rotating part of the machine.
